(19) United States
(12) Patent Application Publication
(10) Pub. No.: US 2022/0029514 A1
(43) Pub. Date: Jan. 27, 2022

(54) A LINEAR MOTOR AND METHOD OF ASSEMBLING STATOR SEGMENTS IN THE LINEAR MOTOR

(71) Applicant: Intelline Inc., Kitchener (CA)

(72) Inventors: Kyle Timothy Faller, Waterloo (CA); Jason Ron Rwang Young, Oakville (CA)

(73) Assignee: Intelline Inc., Kitchener, ON (CA)

(21) Appl. No.: 17/297,226

(22) PCT Filed: Nov. 25, 2019
(86) PCT No.: PCT/IB2019/060134

§ 371 Date: May 26, 2021

Related U.S. Application Data
(60) Provisional application No. 62/771,252, filed on Nov. 26, 2018.

(51) Int. Cl. H02K 41/03

(52) U.S. Cl. CPC H02K 41/03

(57) ABSTRACT

Example linear motors, linear compressors, and methods to assemble linear motors and linear compressors are described. An example linear motor includes a stator drive assembly and a mover drive assembly. The stator drive assembly includes a series of stator segments, each stator segment stackable on top of one another, and one or more stator alignment features to align the stator segments with a linear motor axis. The mover drive assembly includes one or more mover segments to be driven to move along the linear motor axis when induced by an electric current running through the series of stator segments. Such a linear motor may form part of an example linear compressor.

### FIELD

The present invention relates to linear motors and linear compressors, and in particular, to drive components for linear motors and linear compressors.

### BACKGROUND

A linear motor is an electric motor that produces a magnetic force to accelerate a mover along its length. Linear motors may be used in linear compressors, maglev trains, projectile weapons, or other applications in which a mover is to be accelerated in a linear direction. A linear compressor harnesses the motion of a linear motor to compress a fluid, typically a gas, such as in the case of a refrigeration process.

### SUMMARY

According to an aspect of the specification, a linear motor includes a stator drive assembly and a mover drive assembly. The stator drive assembly includes a series of stator segments, each stator segment stackable on top of one another, and one or more stator alignment features to align the stator segments with a linear motor axis. The mover drive assembly includes one or more mover segments to be driven to move along the linear motor axis when induced by an electric current running through the series of stator segments.

According to another aspect of the specification, a linear motor includes a stator drive assembly and a mover drive assembly. The stator drive assembly includes a series of stator segments and one or more stator spacers, each stator spacer stackable between any two stator segments of the series of stators. The stator drive assembly further includes one or more stator alignment features to align the stator segments and the stator spacers with a linear motor axis. The mover drive assembly includes one or more mover segments to be driven to move along the linear motor axis when induced by an electric current running through the series of stator segments.

According to yet another aspect of the specification, a method for assembling a linear motor includes stacking together a series of stator segment, stacking together a series of mover segments, and aligning the series of stator segments and the series of mover segments with a linear motor axis such that the mover segments are to be driven to move along the linear motor axis when induced by an electric current running through the series of stator segments. Such a method for assembling a linear motor may be extended into the assembly of a linear compressor.

### BRIEF DESCRIPTION OF THE DRAWINGS

FIG. 1 is a schematic diagram of an example linear motor with stackable drive components.

FIG. 2 is a schematic diagram of an example linear compressor with stackable drive components.

FIG. 3 is a schematic diagram of another example linear motor with stackable drive components, the linear motor including stator spacers which are stackable between stator segments of the linear motor.

FIG. 4 is a cross-sectional view of an example linear compressor unit with stackable drive components.

FIG. 5 is an isometric view of the exterior of the example linear compressor unit of FIG. 4.

FIG. 6 is an isometric cross-sectional view of an example linear compressor unit in an opposed configuration and with stackable drive components.

FIG. 7 is an exploded perspective view of an example linear compressor drive assembly with stackable drive components.

FIG. 8 is a perspective view of the example linear compressor drive assembly of FIG. 7.

FIG. 9 is an exploded isometric view of an example stator drive assembly of the linear compressor drive assembly of FIG. 7.

FIG. 10 is a perspective view of an example stator segment and stator spacer of the stator drive assembly of FIG. 9.

FIG. 11 is an isometric view of an example mover drive assembly of the linear compressor drive assembly of FIG. 7.

FIG. 12 is a cross-sectional view of the example mover drive assembly of FIG. 11.

FIG. 13 is a flowchart of an example method for assembling a linear motor with stackable drive components.

FIG. 14 is a flowchart of an example method for assembling a linear compressor with stackable drive components.

### DETAILED DESCRIPTION

Linear motors, and by extension, linear compressors, are typically designed to achieve one or more specific performance targets, either for custom applications or for the manufacture of pre-fabricated units. In either case, designing a linear motor for a specific performance target involves designing and manufacturing the drive components of the linear motor (i.e. the stator and/or mover) with specific dimensions.

On the one hand, the custom design and manufacturing of linear motors is time-consuming and costly. On the other hand, it is not always possible to procure a pre-fabricated unit that is compatible with a larger system of which the pre-fabricated unit is to be a part, and thus, custom design and manufacturing is often inevitable.

The present disclosure proposes example linear motors and linear compressors with stackable drive components which enable the linear motor or linear compressor, as the case may be, to be designed and manufactured with a high degree of customizability quickly and for low cost. Such linear compressors may be particularly useful in cryogenic cooling machines, as such linear compressors offer high-efficiency oil-free operation and may be quickly designed to be customizable for desired performance targets for low costs.

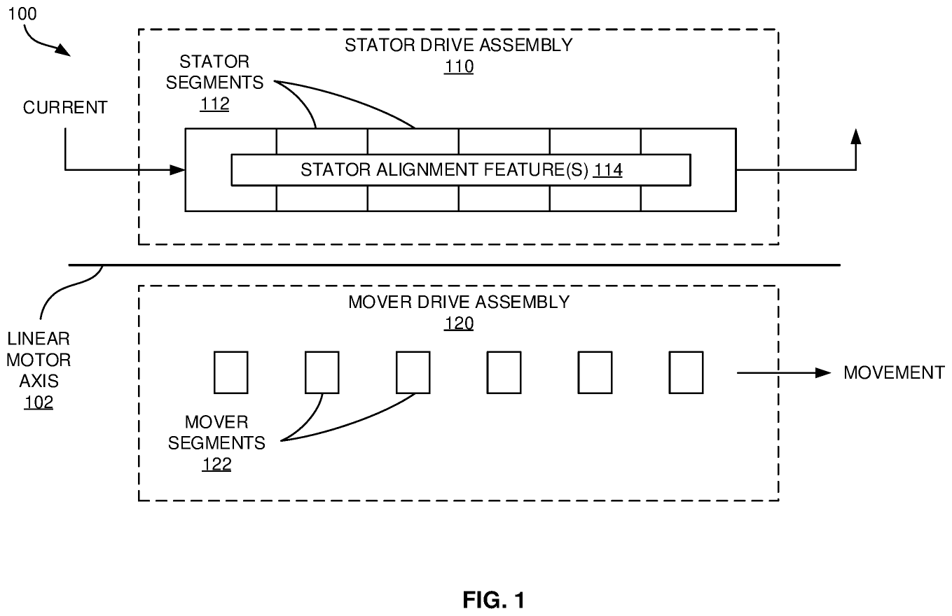

FIG. 1 is a schematic diagram of an example linear motor 100 with stackable drive components. The linear motor 100 includes a stator drive assembly comprising 110 and a mover drive assembly 120. Together, the stator drive assembly 110 and mover drive assembly 120 may be referred to as a linear motor drive assembly.

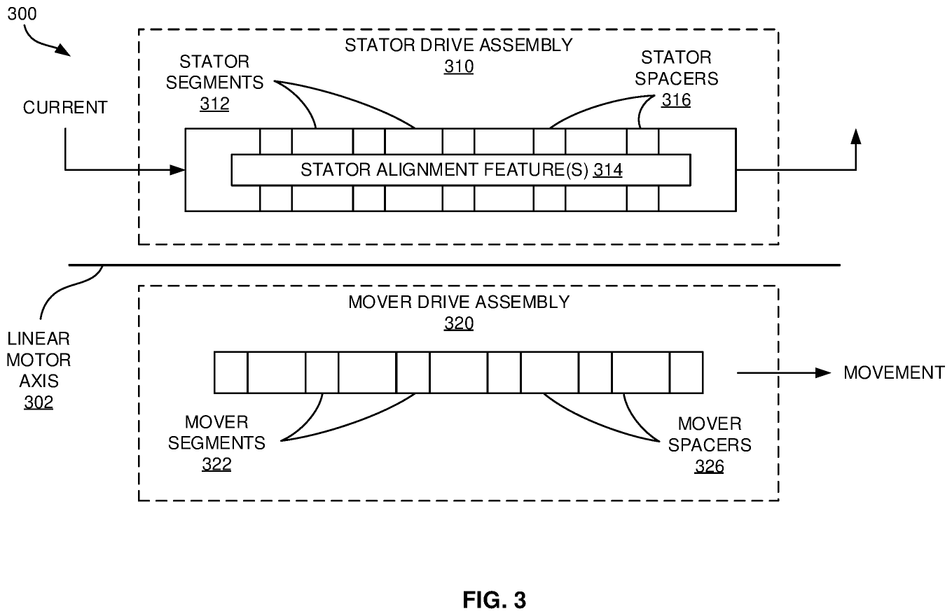

The stator drive assembly 110 includes a series of stator segments 112. Each stator segment 112 is stackable on top of another stator segment 112. In some examples, each stator segment 112 may be uniformly sized. As will be seen below with reference to FIG. 3, in some examples, the stator drive assembly 110 may further include stator spacers to facilitate stacking of the stator segments 112, and to arrange the spacing of the stator segments 112. The stator spacers are made of an electrically insulative material such as aluminum nitride, and may be 3D-printed, injected molded, and/or made of a material that is easy to work with, such as plastic or nylon.

The stator drive assembly 110 further includes one or more stator alignment features 114 to align the stator segments 112 with a linear motor axis 102. In some examples, a stator alignment feature 114 may include, as will be described in further examples below, an alignment pin running through the series of stator segments 112.

In some examples, a stator alignment feature 114 may include a structural feature of one stator segment 112 that cooperates with another structural feature of another stator segment 112 to align the two stator segments 112. For example, a stator alignment feature 114 may include a particular structural feature of a particular stator segment 112 of the series of stator segments 112, and a second structural feature of a second stator segment 112 of the series of stator segments 112. The particular structural feature and the second structural feature may interlock to align the particular stator segment 112 and the second stator segment 112 with the linear motor axis 102 when the particular stator segment 112 is stacked adjacently on top of the second stator segment 112.

The mover drive assembly 120 includes one or more mover segments 122 to be driven to move along the linear motor axis 102 when induced by an electric current running through the series of stator segments 112. In some examples, the mover drive assembly 120 may include at least two mover segments 122, and the mover drive assembly 120 may further include one or more mover spacers, each mover spacer stackable between any two mover segments of the at least two mover segments. As with stator spacers, such mover spacers may facilitate stacking of the mover segments 122, and may further be to arrange the spacing of the mover segments 122.

Although a plurality of mover segments 122 and stator segments 112 are shown, it is to be understood that in some examples, a single mover segment 122 may be matched with a single stator segment 112 to form a drive assembly for a linear motor.

The number of stator segments 112 and/or the number of mover segments 122 used may be selected according to the specified performance target. For example, higher power output performance targets may be achieved by stacking more stator segments 112 and/or mover segments 122 into the linear motor 100. Further, the stator segments 112 and mover segments 122 may be paired together or arranged against one another to achieve this specified performance target. In other words, a suitable relative distance between a particular mover segment 122 and a particular stator segment 112 along the linear motor axis 102 may be selected to achieve the specified performance target. Further, a particular stator spacer and/or a particular mover spacer may be stacked accordingly to space the particular mover segment 122 apart from the particular stator segment 112 by the suitable relative distance. Thus, the linear motor 100 may be easily designed to achieve a specified performance target, such as power output, without the need for significant deviation from electrical input parameters used for linear motors 100 designed for other similar specified performance targets. Further, the stator spacers and mover spacers may be used as needed to harness or avoid magnetic flux interaction between stator segments 112 and mover segments 122, and/or to align or offset stator segments 112 and mover segments 122, as dictated by the type of motor for of which the linear motor 100 is to be designed, and motion of the mover required by the application. In other words, the stator segments 112, stator spacers, and/or mover segments 122 and mover spacers, may be arranged to achieve a desired force profile when an electric current is run through the stator drive assembly 210.

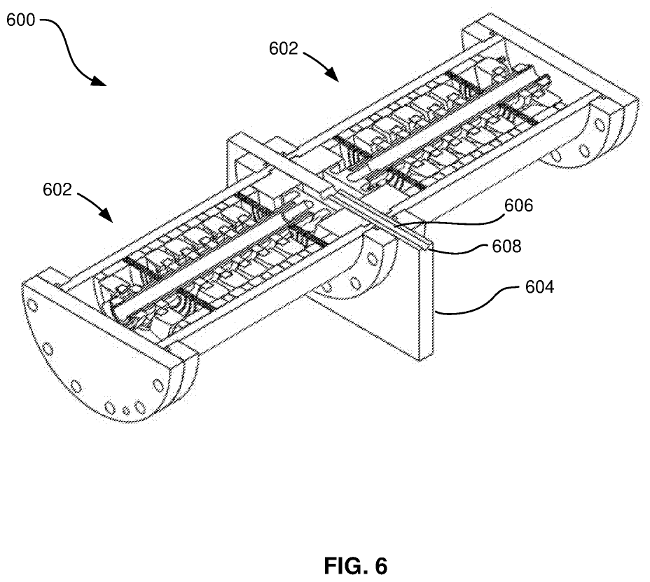

Moreover, the linear motor 100 may be manufactured and stacked with additional similar linear motors 100 to achieve a greater power output, for example, in an opposed configuration, as shown in FIG. 6. Stacking multiple linear motors 100 to achieve a greater power output may be advantageous because a single linear motor 100 may be designed and manufactured and used in multiples to serve a range of linear motor or linear compressor specifications. Manufacturing one linear motor 100 designed to serve multiple specifications lowers the overall cost of the larger system of which the linear motors 100 are to be a part, as the initial costs of development and design of the linear motor 100 is disbursed among a greater number of units.

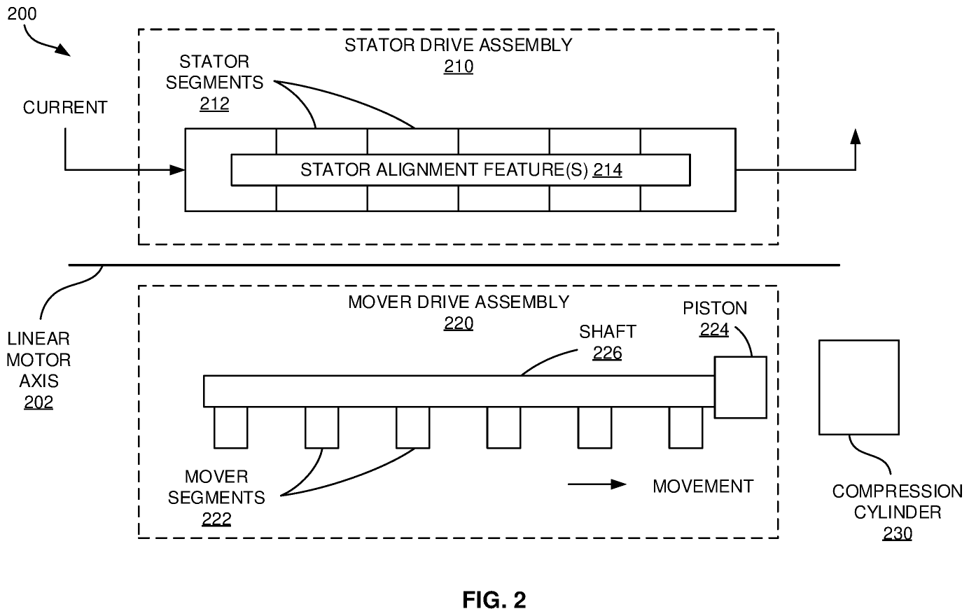

The linear motor 100 may be configured for use in a linear compressor, as shown for example in FIG. 2. FIG. 2 is a schematic diagram of an example linear compressor 200 with stackable drive components. The linear compressor 200 is similar to the linear motor 100 of FIG. 1, and includes like components numbered in the “200” series rather than the “100” series. The linear compressor 200 therefore includes a stator drive assembly 210, stator segments 212, stator alignment features 214, and mover drive assembly 220, mover segments 222, and linear motor axis 202. For further description of the above components, reference may be had to the like components of the linear motor 100 of FIG. 1.

The linear compressor 200 further includes a compression cylinder 230, and the mover drive assembly 220 further includes a piston 224 and a shaft 226 for the piston 224. The mover segments 222 are fixed to the shaft 226 to plunge the piston 224 into the compression cylinder 230 by movement of the mover segments 222. The piston 224 plunging into the compression cylinder 230 may compress a fluid, such as gas, such as in a refrigeration process.

FIG. 3 is a schematic diagram of another example linear motor 300 with stackable drive components. The linear motor 300 is similar to the linear motor 100 of FIG. 1, and includes like components numbered in the “300” series rather than the “100” series. The linear motor 300 therefore includes a stator drive assembly 310, stator segments 312, stator alignment features 314, and mover drive assembly 320, mover segments 322, and linear motor axis 302. For further description of the above components, reference may be had to the like components of the linear motor 100 of FIG. 1.

The linear motor 300 further includes one or more stator spacers 316 which are stackable between any two stator segments 312 of the linear motor 300. The stator spacers 316 to facilitate stacking of the stator segments 312, and to arrange the spacing of the stator segments 312. Further, in some examples, each stator spacer 316 may be uniformly sized, but in other examples, only a subset of stator spacers 316 may be uniformly sized, and one or more of the stator spacers 316 may be differently sized to achieve a particular spacing profile of stator segments 312. Similarly, the linear motor 300 further includes one or more mover spacers 326 which are stackable between any two mover segments 322 of the linear motor 300. The mover spacers 326 are to facilitate stacking of the mover segments 322, and to arrange the spacing of the mover segments 322. Further, in some examples, each mover spacer 326 may be uniformly sized, but in other examples, only a subset of mover spacers 326 may be uniformly sized, and one or more of the mover spacers 326 may be differently sized to achieve a particular spacing profile of mover segments 322.

Further, the stator alignment features 314 align the stator segments 312 and the stator spacers 316 with the linear motor axis 302. For example, a stator alignment features 314 may include an alignment pin running through one or both of the series of stator segments 312 and the one or more stator spacers 316. As another example, a stator alignment features 314 may include a particular structural feature of a particular stator segment 312 of the series of stator segments 312, and a second structural feature of a particular stator spacer 316 of the one or more stator spacers 316. The particular structural feature and the second structural feature may interlock to align the particular stator segment 312 and the particular stator spacer 316 with the linear motor axis 302 when the particular stator segment 312 is stacked adjacently on top of the particular stator spacer 316.

In some examples, at least one of the stator spacers 316 may include one or more cooling features to cool the linear compressor 300 in operation. For example, a stator spacer 316 may be made of a highly thermally conductive material, coated with an electrically insulative coating or lining such as NOMEX® paper, or may include one or more cooling vents.

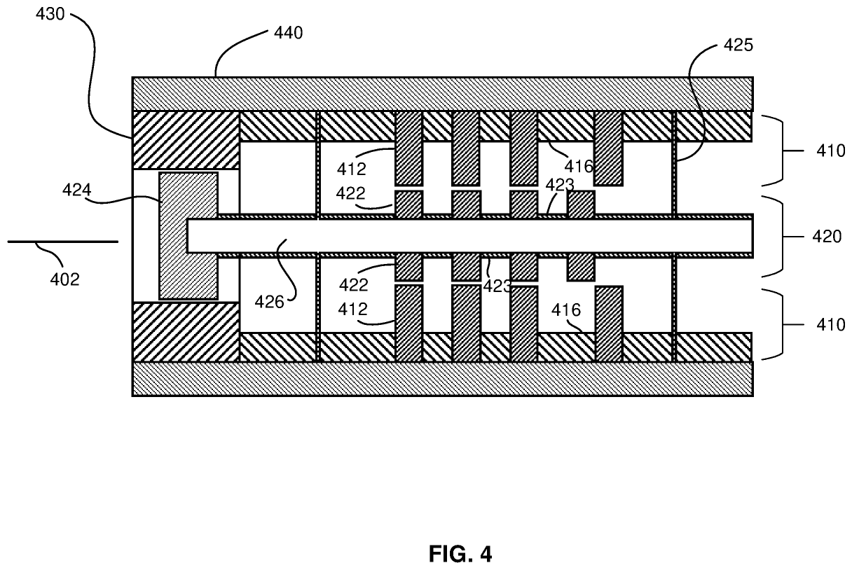

FIG. 4 is a cross-sectional view of an example linear compressor unit 400 with stackable drive components. The linear compressor unit 400 may be understood to be one example of a linear compressor similar to the linear compressor 200 of FIG. 2.

The linear compressor unit 400 includes a linear motor axis 402, stator drive assembly 410, a mover drive assembly 420, piston 424, shaft 426, compression cylinder 430, and shell 440. Together, the stator drive assembly 410, mover drive assembly 420, piston 424, shaft 426, and compression cylinder 430 may be referred to as the linear compressor drive assembly.

The stator drive assembly 410 is located and secured to the compression cylinder 430. The mover segments 422 and mover spacers 423 are fixed to the shaft 426. The piston 424 is located at one end of, and secured to, the shaft 426. The mover drive assembly 420 is arranged radially around the shaft 426 and is thus aligned with the linear motor axis 402. A radial support bearing 425 supports the mover drive assembly 420 in this position. The radial support bearing 425 may be termed a mover support. The shell 440 provides structural support to the linear compressor unit 400, and may further provide locating features, cooling features, and containment of fluid as a pressure vessel.

The stator drive assembly 410 includes a series of stator segments 412 and stator spacers 416, which are stacked together to form an adequately sized stator to achieve a specified performance target. Similarly, the mover drive assembly 420 includes one or more mover segments 422 and mover spacers 423, which are stacked together to form an adequately sized mover to achieve the specified performance target. As discussed above with reference to FIG. 1, the number of stator segments 412 and/or the number of mover segments 422 used, and the relative distances therebetween along the linear motor axis 402, may be selected according to the specified performance target. Further, a particular mover segment 422 may be offset by a suitable distance from a neighboring stator segment 412 so that the particular mover segment 422 is initially displaced when an electrical current is run through the stator drive assembly 410.

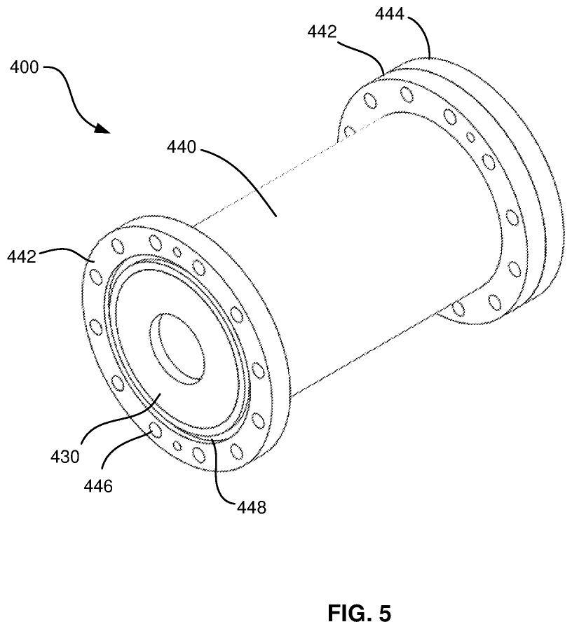

FIG. 5 is an isometric view of the exterior of the linear compressor unit 400. The linear compressor unit 400 as further shown as including flanges 442 attached to the shell 440 to enable end caps 444 to be installed. Alternatively, the linear compressor unit 400 may be secured to a manifold to regulate fluid flow in or out of the compression cylinder 430. Each flange 442 includes bolt holes 446 and an o-ring groove 448 to enable end caps 444 or a manifold to seal the shell 440. Alternatively, a gasket, adhesive, welding, or other joining process may be used to secure and seal end caps 444 or a manifold to the shell 440.

FIG. 6 is an isometric cross-sectional view of an example linear compressor unit 600 in an opposed configuration and with stackable drive components. The linear compressor unit 600 includes two linear compressor units 602 secured to a central manifold 604. Each linear compressor unit 602 may be similar to the linear compressor unit 400 of FIG. 4 and/or the linear compressor 200 of FIG. 2. Stacking two linear compressor units 602 in opposed configuration may reduce vibration in the linear compressor unit 600.

The central manifold 604 includes a fluid channel 606 which allow for fluid flow between a space enclosed by respective compressive cylinders of the two linear compressor units 602 and an output application. The fluid channel 606 terminates at a port 608, which may be an inlet, outlet, or both, depending on the application of the linear compressor unit 600.

In some examples, the linear compressor unit 600 may serve as a pressure wave generator, in which an oscillating motion of the pistons of the two linear compressor units 602 create an oscillating pressure output at the port 608. In further examples, with the addition of another port 608 and fluid channel 606 in the central manifold 604, along with a check valve, valvular conduit, or any other form of one-way flow valve, the linear compressor unit 600 may serve in a reservoir application to increase or decrease the pressure in the reservoir, rather than for creating oscillating flow. In such a configuration, the linear compressor unit 600 may function as a pump to move fluid between two reservoirs or applications. The combination of two linear compressor units 602 and central manifold 604 may also be modular, as additional linear compressor units 602 and corresponding fluid channels 606 may be used to achieve a greater fluid pumping force than one linear compressor unit 602. In still further examples, the central manifold 604 may include more than two ports 608 such that the linear compressor unit 600 may serve multiple applications or fluid lines.

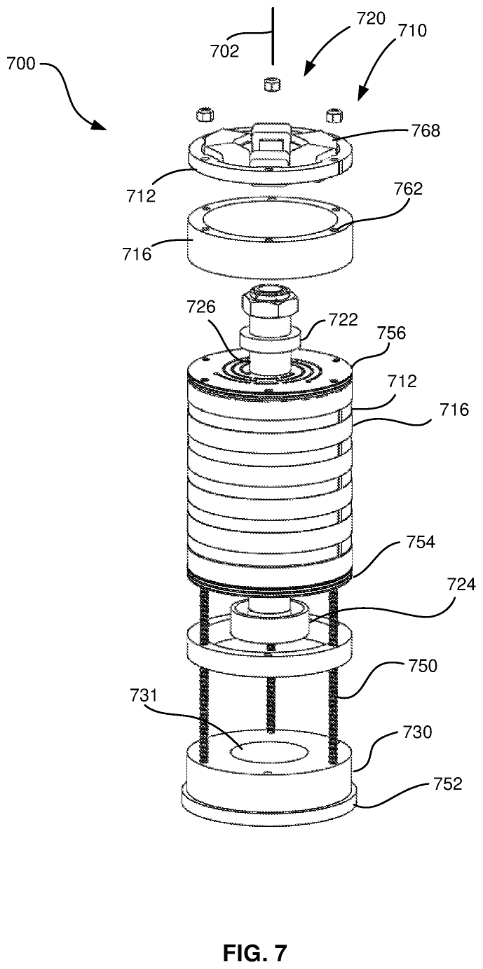

FIG. 7 is an exploded perspective view of an example linear compressor drive assembly 700 with stackable drive components. The linear compressor drive assembly 700 includes a stator drive assembly 710, which may be similar to the stator drive assembly 110 of FIG. 1 and/or the stator drive assembly 410 of FIG. 4, and a mover drive assembly 720, which may be similar to the mover drive assembly 120 of FIG. 1 and/or the mover drive assembly 420 of FIG. 4. As shown, the linear compressor drive assembly 700 is configured to produce an oscillating linear motion of its mover drive assembly 720, and its linear motor is configured as a switched reluctance motor.

The stator drive assembly 710 includes a series of stator segments 712 and stator spacers 716 stacked between the stator segments 712. Each stator segment 712 includes stator windings 768 to carry electrical current through the stator segments 712.

The linear compressor drive assembly 700 includes a compression cylinder 730 which include threaded holes for studs 750 to fasten the stator segments 712 and stator spacers 716 to the compression cylinder 730. The linear compressor drive assembly 700 further includes a locating step 752 to locate the compression cylinder 730 and by extension the linear compressor drive assembly 700 in a shell when the linear compressor drive assembly 700 is to be inserted into a shell. The piston 724 is aligned to plunge into an opening 731 in the compression cylinder 730. The linear compressor drive assembly 700 further includes alignment holes 762 for alignment pins to run through the stator segments 712 and stator spacers 716 to serve as alignment features to align components of the linear compressor drive assembly 700 with the main axis 702 of the linear compressor drive assembly 700.

The linear compressor drive assembly 700 further includes radial support bearings 754 and flexure springs 756. The radial support bearings 754 and flexure springs 756 together may be referred to as a mover support. The flexure springs 756 allow the shaft 726 to displace with reasonable freedom in the axial direction, and provides adequate rigidity in the radial direction such that the shaft 726 remains radially located with reasonable precision. Alternatively, other forms of linear bearings may be used, such as a coiled or leaf spring, or a bushing, which may be fixed to the shaft 726 to provide restoring forces.

Although configured as a switched reluctance type motor, the linear compressor drive assembly 700 may be reconfigured for other types of linear motors, such as permanent magnet linear motors, in which stator segments 712 and mover segments 722 are configured such that spring restoring forces are not required to create an oscillating motion. Further, in some configurations, a linear motor may be configured to electrically excite a mover to produce an electromagnetic field interacting with the stator to produce a force.

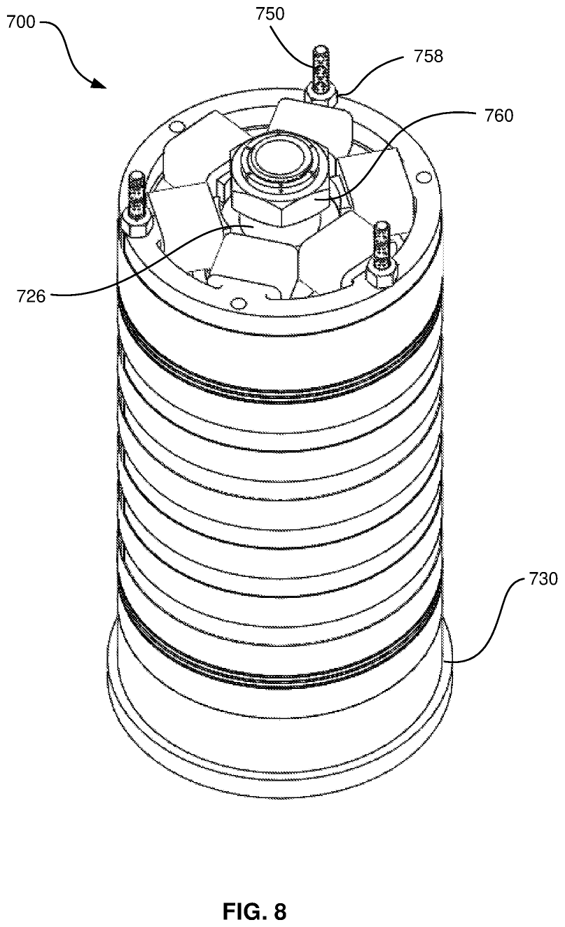

FIG. 8 is a perspective view of the linear compressor drive assembly 700. As shown, the linear compressor drive assembly 700 further includes stator nuts 758 to fasten with studs 750 to secure the stator drive assembly 710, radial support bearings 754, and stator spacers 716 to the compression cylinder 730.

On assembly, the stator segments 712 and stator spacers 716 may be joined together prior to assembly of the remainder of the stator drive assembly 710, or alternatively, the stator segments 712 and stator spacers 716 may be stacked together onto the studs 750 and fastened together with stator nuts 758 to be joined together during assembly with the remainder of the linear compressor drive assembly 700.

On assembly, a shaft nut 760 is used to secure the mover segments 722 and mover spacers 723 on the shaft 726. Alternatively, adhesives, welding, or other methods of joining may be used to secure the mover segments 722 and mover spacers 723 on the shaft 726.

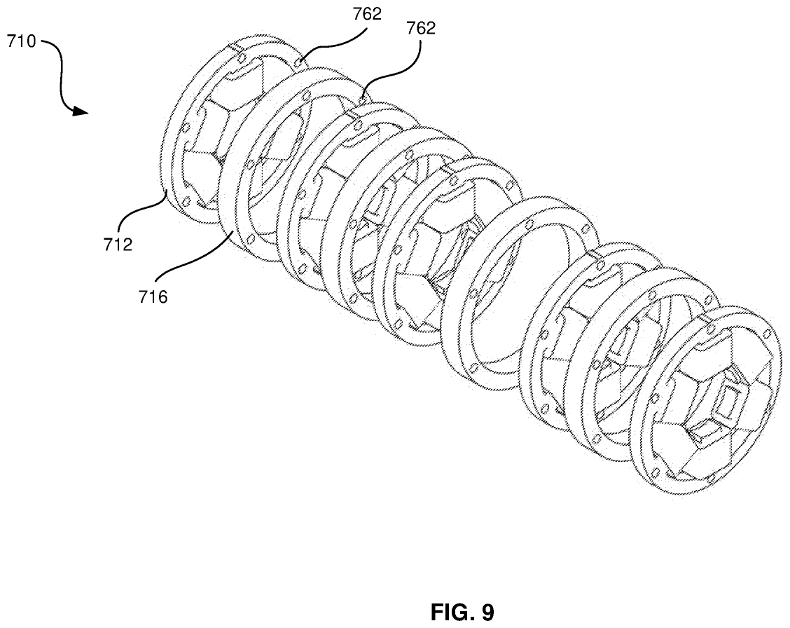

FIG. 9 is an exploded isometric view of the stator drive assembly 710 of the linear compressor drive assembly 700. The stator drive assembly 710 includes alignment holes 762 through the stator segments 712 and stator spacers 716 through which alignment pins may be inserted to align the stator segments 712 and stator spacers 716 with the main axis 702 of the stator drive assembly 710. Alternatively, or in addition, the interior faces of the stator segments 712 and stator spacers 716 may include structural features which interlock with one another to align the stator segments 712 and stator spacers 716 with the main axis 702 of the stator drive assembly 710.

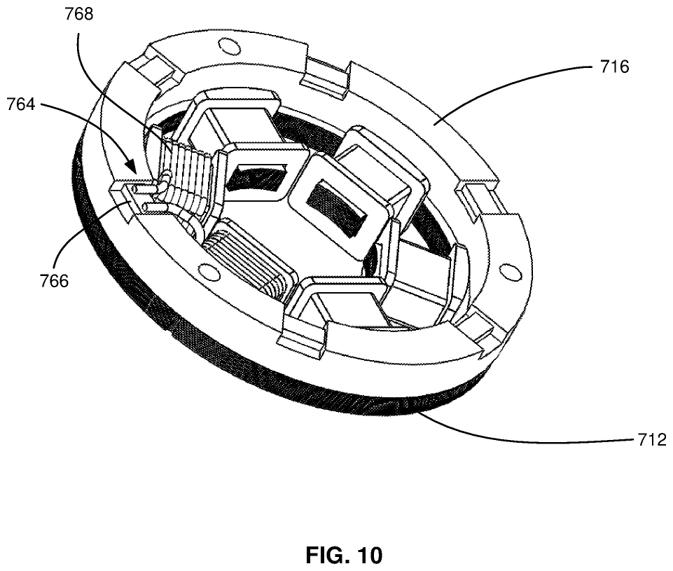

FIG. 10 is a perspective view of a stator segment 712 and stator spacer 716 of the stator drive assembly 710. The stator spacer 716 includes cutouts 764 to provide feed-through access to one or more bus bars 766 which provide electrical connection between electrical leads of stator windings 768 of adjacently stacked stator segments 712.

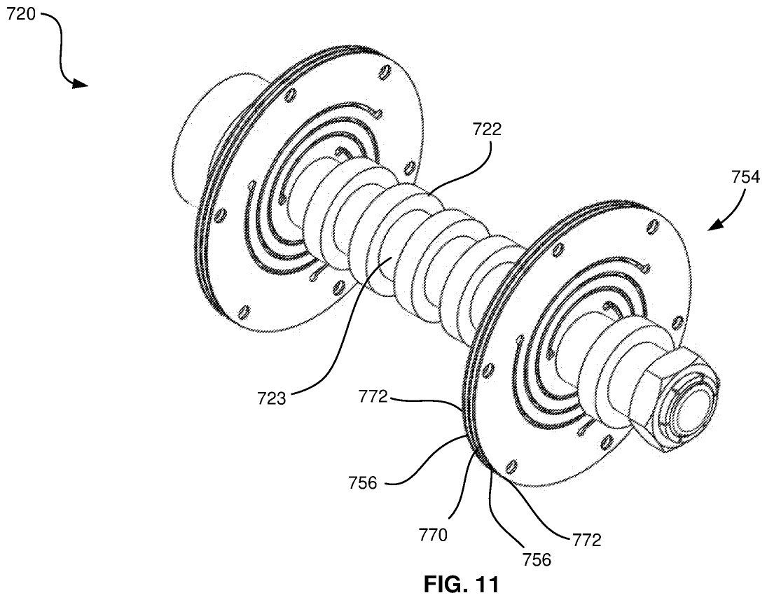

FIG. 11 is an isometric view of the mover drive assembly 720 of the linear compressor drive assembly 700. The mover drive assembly 720 includes radial support bearings 754 which include flexure springs 756 that provide resisting spring forces. On assembly, a flexure spring 756 may be stacked after the final mover spacers 723 on either end of the series of mover spacers 723. If more flexure springs 756 are desired, a plurality of flexure springs 756 may be stacked with flexure spring inner spacers 770 between adjacent flexure springs 756. Further, flexure spring outer spacers 772 may be stacked at each end of the stack of flexure springs 756 and flexure spring inner spacers 770 such that the stack is not stressed when assembled at an equilibrium position.

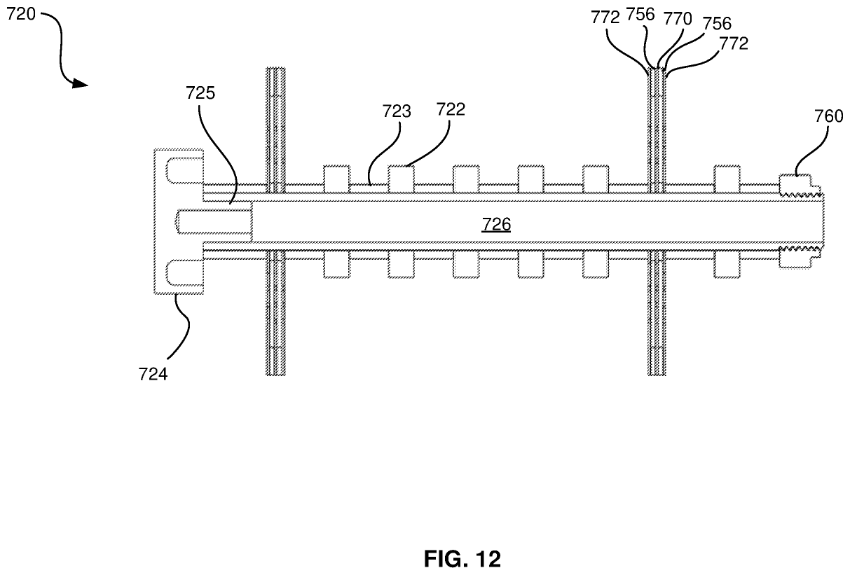

FIG. 12 is a cross-sectional view of the example mover drive assembly 720. The shaft 726 is hollow. The piston 724 includes a protrusion 725 to be slidably received into the shaft 726 to join the piston 724 to the shaft 726. Alternatively, the shaft 726 may be pressed into an opening in the piston 724, or the shaft 726 and piston 724 may be joined by fasteners, adhesives, welding, or other joining methods, or the shaft 726 and piston 724 may be formed of a single material. However, one advantage of the shaft 726 and piston 724 being separate components is that the piston 724 may be sized separately from the shaft 726 to produce a suitable displacement for a given application of the mover drive assembly 720.

The mover spacers 723, mover segments 722, flexure springs 756, flexure spring inner spacers 770, and flexure spring outer spacers 772 are compressed between the inner face of the piston 724 and the shaft nut 760. Alternatively, these components may be compressed between the shaft nut 760 and a step feature in the shaft 726, or secured to the shaft 726 by adhesives or other joining methods. Mover spacers 723 may be of various lengths, to offset mover segments 722 as desired.

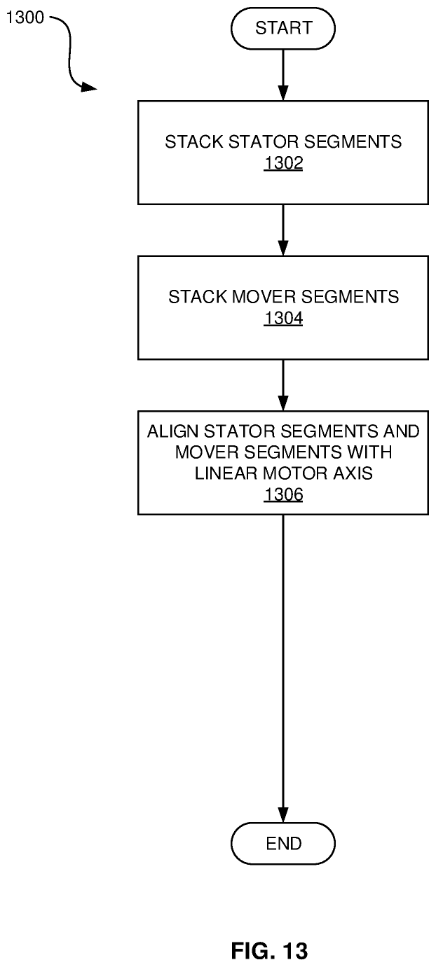

FIG. 13 is a flowchart of an example method 1300 for assembling a linear motor with stackable drive components. The method 1300 is described with reference to the components of the linear motor 100 of FIG. 1, but this is not limiting, and the method 1300 may be used to assembly other linear motors. Further, it is emphasized that the method 1300 need not be performed in the exact sequence as shown.

At block 1302, a series of stator segments 112 is stacked together. One or more stator spacers may be stacked between stator segments 112, as described above.

At block 1304, a series of mover segments 122 is stacked together. The mover segments 122 may be stacked along a shaft, as described above. Further, one or more mover spacers may be stacked between mover segments 122, as described above.

At block 1306, the series of stator segments 112 and the series of mover segments 122 is aligned with the linear motor axis 102 such that the mover segments 122 are to be driven to move along the linear motor axis 102 when induced by an electric current running through the series of stator segments 112.

It is emphasized that the method 1300 need not be performed in the exact sequence as shown. For example, the mover segments 122 may be stacked before, after, or simultaneous with, the stator segments 112 being stacked. Further, the mover segments 122 may be aligned before, after, or simultaneous with, the stator segments 112 and/or mover segments 122 being stacked.

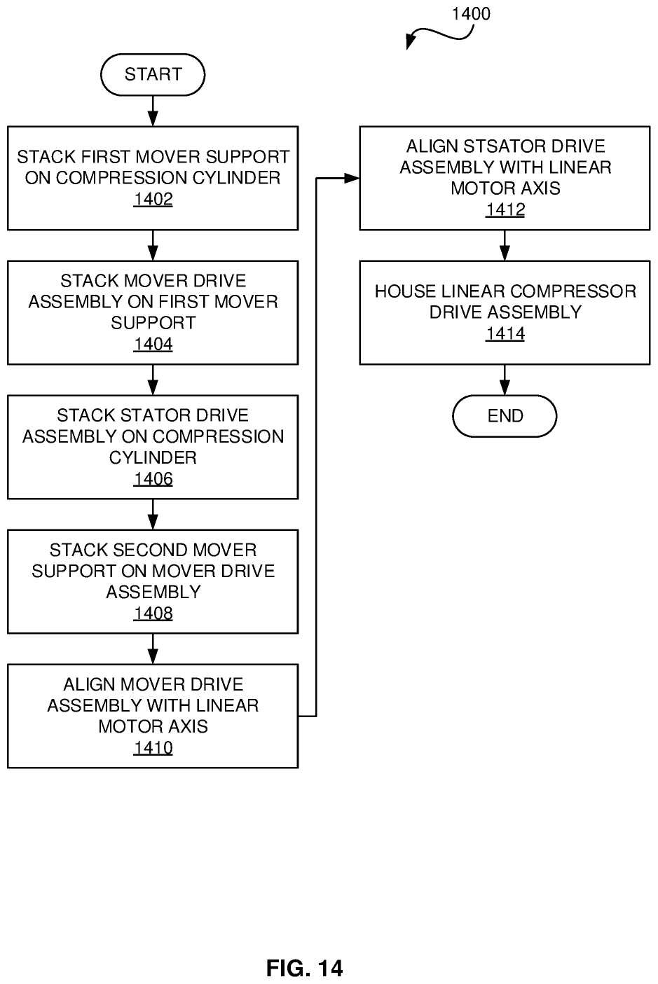

FIG. 14 is a flowchart of an example method 1400 for assembling a linear compressor with stackable drive components. The method 1400 may be understood as one example of how the method 1300 for assembling a linear motor may be extended to the assembly of a linear compressor. The method 1400 is described with reference to the components of the linear compressor 200 of FIG. 2, but this is not limiting, and the method 1400 may be used to assembly other linear motors. Further, it is emphasized that the method 1400 need not be performed in the exact sequence as shown.

At block 1402, a first mover support is stacked onto a compression cylinder 230. The mover support may include radial support bearings (e.g. as in the linear compressor unit 400 of FIG. 4), or support bearings and flexure springs (e.g. as in the linear compressor drive assembly 700 of FIG. 7).

At block 1404, the mover drive assembly 220 is stacked onto the first mover support. The mover drive assembly 220 may include a shaft onto which mover segments 222 and mover spacers are fixed (e.g. as in the linear compressor drive assembly 700 of FIG. 7).

At block 1406, the stator drive assembly 210 is stacked onto the compression cylinder 230.

At block 1408, a second mover support is stacked onto the mover drive assembly 220.

At block 1410, the mover drive assembly 220 is aligned with the linear motor axis 202. The mover drive assembly 220 may be aligned with the linear motor axis 202 by being fixed to a shaft that defines the linear motor axis 202. Similarly, at block 1412, the stator drive assembly 210 is aligned with the linear motor axis 202. The stator drive assembly 210 may be aligned by the insertion of one or more alignment features, such as alignment pins, through alignment holes in the stator segments 212 and/or stator spacers.

At block 1414, the linear compressor drive assembly (i.e. the stator drive assembly 210 and mover drive assembly 220) is housed. The linear compressor drive assembly may be housed with a shell, flanges, and end caps (e.g. as in the linear compressor unit 400 of FIG. 5), or by other housing mechanisms.

It is emphasized that the method 1400 need not be performed in the exact sequence shown. For example, the stator drive assembly 210 may be stacked before, after, or during the mover drive assembly 220 being stacked, and/or the stator drive assembly 210 and/or mover drive assembly 220 being aligned with the linear motor axis 202.

Thus, linear motors and linear compressors may be designed and assembled with stackable drive components for a more speedy and low-cost design and manufacturing process. Such linear motors may be designed with a suitable number of stator segments and/or mover segments, and in a suitable arrangement to produce a specified force profile, to achieve a specified performance target. Moreover, multiple of such linear motors may be stacked together for increased performance. Linear compressors produced using such linear motors may be particularly useful in cryogenic cooling machines, as such linear compressors offer high-efficiency oil-free operation and may be quickly designed to customizable for desired performance targets for low costs.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A linear motor comprising:
a stator drive assembly comprising:
a series of stator segments, each stator segment stackable on top of one another; and
one or more stator alignment features to align the stator segments with a linear motor axis; and
a mover drive assembly comprising:
one or more mover segments to be driven to move along the linear motor axis when induced by an electric current running through the series of stator segments.

2. The linear motor of claim 1, wherein each stator segment of the series of stators is uniformly sized.

3. The linear motor of claim 1, wherein the one or more stator alignment features comprises an alignment pin running through the series of stator segments.

4. The linear motor of claim 1, wherein the one or more stator alignment features comprises:
a first structural feature of a first stator segment of the series of stator segments; and
a second structural feature of a second stator segment of the series of stator segments;
wherein the first structural feature and the second structural feature interlock to align the first stator segment and the second stator segment with the linear motor axis when the first stator segment is stacked adjacently on top of the second stator segment.

5. The linear motor of claim 1, wherein:
the linear motor further comprises a compression cylinder; and
the mover drive assembly further comprises a piston and a shaft for the piston, the mover segments fixed to the shaft to plunge the piston into the compression cylinder by movement of the mover segments.

6. The linear motor of claim 1, wherein the mover drive assembly comprises at least two mover segments, and the mover drive assembly further comprises one or more mover spacers, each mover spacer stackable between any two mover segments of the at least two mover segments.

7. A linear motor comprising:
a stator drive assembly comprising:
a series of stator segments;
one or more stator spacers, each stator spacer stackable between any two stator segments of the series of stators;
one or more stator alignment features to align the stator segments and the stator spacers with a linear motor axis; and
a mover drive assembly comprising:
one or more mover segments to be driven to move along the linear motor axis when induced by an electric current running through the series of stator segments.

8. The linear motor of claim 7, wherein the mover drive assembly comprises at least two mover segments, and the mover drive assembly further comprises one or more mover spacers, each mover spacer stackable between any two mover segments of the at least two mover segments.

9. The linear motor of claim 7, wherein each stator spacer is uniformly sized.

10. The linear motor of claim 7, wherein the one or more stator alignment features comprises an alignment pin running through one or both of the series of stator segments and the one or more stator spacers.

11. The linear motor of claim 7, wherein the one or more stator alignment features comprises:
a first structural feature of a first stator segment of the series of stator segments; and
a second structural feature of a first stator spacer of the one or more stator spacers;
wherein the first structural feature and the second structural feature interlock to align the first stator segment and the first stator spacer with the linear motor axis when the first stator segment is stacked adjacently on top of the first stator spacer.

12. The linear motor of claim 7, wherein at least one stator spacer of the one or more stator spacers includes a cooling feature.

13. A method for assembling a linear motor, the method comprising:
stacking together a series of stator segments;
stacking together a series of mover segments; and
aligning the series of stator segments and the series of mover segments with a linear motor axis such that the mover segments are to be driven to move along the linear motor axis when induced by an electric current running through the series of stator segments.

14. The method of claim 13, further comprising one or more of:
stacking one or more stator spacers between a first and second stator segment of the series of stator segments; and
stacking one or more mover spacers between a first and second mover segment of the series of mover segments.

15. The method of claim 13, further comprising one or more of:
selecting a number of stator segments to be included in the series of stator segments according to a specified performance target;
selecting a number of stator segments to be included in the series of mover segments according to a specified performance target; and
selecting a suitable relative distance between a first mover segment of the series of mover segments and a first stator segment of the series of stator segments along the linear motor axis according to a specified performance target, and stacking one or more of a first stator spacer within the series of stator segments and a first mover spacer within the series of mover segments to space the first mover segment apart from the first stator segment by the suitable relative distance.
